(19) United States
(12) Patent Application Publication
(10) Pub. No.: US 2010/0120466 A1
(43) Pub. Date: May 13, 2010

(54) MULTI-MODE ANTENNA SWITCHING

(75) Inventor: Kevin Li, San Diego, CA (US)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/269,120

(22) Filed: Nov. 12, 2008

(51) Int. Cl. H04M 1/00; H04B 1/40

(52) U.S. Cl. 455/552.1; 455/73

(57) ABSTRACT

The present invention relates to a method, an apparatus, and a computer program for providing multi-mode antenna switching, wherein a processor is configured to determine active radio protocols of a radio communication and a mode of use of the apparatus, and to control the selection of at least one antenna for the radio communication in response to which radio protocols are active and how the apparatus is used or held.

### FIELD OF THE INVENTION

The present invention relates to a method, an apparatus, and a computer program for antenna switching in a multi-antenna multi-receiver/transceiver device.

### BACKGROUND OF THE INVENTION

The number of radio protocols provided in portable electronic devices (for example mobile phones, personal digital assistants (PDAs), mobile computing devices, etc.) is increasing due to a demand in the communications industry for more functions and services. Hence, more antennas are required to enable these radio protocols in the devices.

In particular, mobile or cellular phones are incorporating more and more antennas, as well as more and more protocols. Dynamically tuned antennas are being researched and developed. As an example, separate antennas may be provided for a fixed set of frequencies and protocols. For example, one antenna for Global System for Mobile Communications (GSM) and/or Wideband Code Division Multiple Access (WCDMA), one antenna for Global Positioning System (GPS), one antenna for Bluetooth (BT) and/or Wireless Local Area Network (WLAN) (or one antenna for GPS and BT), one antenna for Digital Video Broadcasting Handhelds (DVB-H), one antenna for receiver (Rx) diversity for GSM/WCDMA.

Furthermore, in so-called Multiple Input Multiple Output (MIMO) systems antenna arrays are used to enhance bandwidth efficiency. MIMO systems provide multiple inputs and multiple outputs for a single channel and are thus able to exploit spatial diversity and spatial multiplexing. Further information about MIMO systems can be gathered for example from the IEEE specifications 802.11n, 802.16-2004 and 802.16e, as well as 802.20 and 802.22 which relate to other standards. Specifically, MIMO systems have been introduced to radio systems like, for example Wi-MAX (Worldwide Interoperability for Microwave Access) and are currently standardized in 3GPP for WCDMA as well as 3^{rd} Generation Partnership Project (3GPP) Enhanced Universal Mobile Telecommunications System (UMTS) Terrestrial Radio Access Network (E-UTRAN), such as LTE (Long Term Evolution) or 3.9G.

### SUMMARY

According to various, but not necessarily all, embodiments there is provided an apparatus, comprising a processor configured to determine at least one active radio protocol of radio communication and a mode of use of the apparatus, and to control selection of at least one of a plurality of antennas to be used for the radio communication in response to the determined at least one active radio protocol and the determined mode of use of the apparatus.

Furthermore, according to various, but not necessarily all, embodiments, there is provided a method comprising:
determining at least one active radio protocol of a radio communication and a mode of use of a communication apparatus; and
selecting at least one of a plurality of antennas in response to the at least one determined active radio protocol and the determined mode of use of the apparatus.

Further, according to various, but not necessarily all, embodiments there is provided a transmitting or receiving device comprising an apparatus as defined above, and further comprising:
a plurality of antennas; and
a switching matrix configured to select at least one of the plurality of antennas, and to couple the selected antenna(s) to at least one of a plurality of transmitters and receivers;
wherein the processor is configured to control the switching matrix.

According to various, but not necessarily all, embodiments of the invention there is provided a computer program embodied on a computer-readable storage medium, the computer program being configured to control a processor to perform a process comprising determining at least one active radio protocol of a radio communication and a mode of use of a communication apparatus; and controlling selection of at least one antenna for the apparatus in response to the at least one determined active radio protocol and the determined mode of use of the apparatus.

According to various, but not necessarily all, embodiments of the invention there is provided an apparatus comprising a processor and a memory storing executable instructions that control the processor configured to determine at least one active radio protocol of a radio communication and a mode of use of the apparatus, and to control selection of at least one of a plurality of antennas to be used for the radio communication in response to the at least one determined active radio protocol and the determined mode of use of the apparatus.

The “processor” and “memory” may comprise a computer processor, application specific integrated circuit (ASIC), field programmable gate array (FPGA), one or more memories (for example a read-only memory (ROM), a compact disc ROM (CDROM), a memory stick, a memory card, etc), and/or other hardware components that have been programmed in such a way to carry out the above instructions.

Accordingly, an antenna can be tuned to cover multiple frequency bands and/or devices can be provided which can support concurrent use of multiple protocols. Particular antennas can be assigned to certain frequencies and radio protocols based on the mode of use. The mode of use may comprise—among other criteria—how the user is using or holding the phone. Thereby, the number of discrete antennas required for the apparatus can be reduced significantly, for example, based on the maximum number of concurrent protocols supported, rather than the maximum number of protocols supported. For example, four dynamically tuned antennas may support cellular services (Global System for Mobile Communications (GSM), Wideband Code Division Multiple Access (WCDMA), Long Term Evaluation (LTE), etc.), Wireless Local Area Networks (WLAN), such as Wireless Fidelity (WiFi), Worldwide Interoperability for Microwave Access (WiMax) etc., Global Positioning System (GPS), Digital Video Broadcasting-Handhelds (DVB-H), Bluetooth (BT), receiver (Rx) or transmitter (Tx) diversity (or Multiple Input Multiple Output (MIMO)) for GSM/WCDMA/LTE, Rx/Tx diversity (or MIMO) for WLAN (WiFi, WiMax), FM Radio (Rx and/or Tx), etc.

Thus, each antenna may be used for a set of frequencies and protocols, and could be dynamically tuned, for example, in accordance with desired protocol(s). As another option, switched antennas (for example two GPS antennas) may be provided, where an antenna could be selected based on what mechanical mode the phone is in (for example fold open or closed).

A smaller number of antennas thus enables the support of many transceivers, transmitters or receivers. The proposed antenna selection can be optimized based on numerous inputs.

The mode of use may be determined based on at least one of sensor input, a mechanical mode of the apparatus, and a type of software running on the apparatus.

Furthermore, at least one antenna may be selected based on a user effect of the mode of use, and at least one of an emissions compliance of a hearing aid, a specific absorption rate compliance, a mechanical mode of the apparatus, a battery conservation status, and the signal strengths received by the apparatus or an access device (e.g. base station, access point or the like) of determined active protocols.

The processor which is used to control the switching matrix may be configured to be controlled by a reconfigurable software. This provides flexibility for set-up or future modifications.

The number of the plurality of antennas may be selected to correspond to the maximum number of concurrent radio protocols which can be operated at any one time.

Additionally, at least one of the plurality of antennas may be tuned to frequency ranges of a plurality of the radio protocols.

The switching matrix may be configured to couple each of the plurality of antennas to each of the plurality of radio transmitters or receivers. In a specific example, it may be configured as a replaceable unit.

A plurality of sensors may be provided for determining at least one of the modes of use and the active radio protocols. More specifically, the sensors may be configured to detect at least one of an orientation of a portable electronic device, an open feature, for example, when the device is in either an open or closed state (as found in slide, rotating or fold phones for example), and a way a user is holding the device in his/her hand or against his/her head.

In specific implementations, the radio protocols may comprise at least one of a cellular protocol, a wireless local area network protocol, a global positioning system protocol, a digital video broadcasting protocol, a Bluetooth protocol, a Frequency Modulation (FM) reception or transmission protocol, and a reception and/or transmit diversity protocol.

Further advantageous modifications or developments are defined in the dependent claims.

### BRIEF DESCRIPTION OF THE DRAWINGS

Various embodiments will now be described with reference to the accompanying drawings in which:

FIG. 1 shows a schematic block diagram of an apparatus according to a first embodiment;

FIG. 2 shows a flow diagram of an antenna switching method according to a second embodiment;

FIG. 3 shows a schematic block diagram of an apparatus according to a third embodiment;

FIG. 4 schematically shows an antenna arrangement of a multi-antenna transceiver device according to a fourth embodiment; and

FIG. 5 a schematic block diagram of a computer-based implementation according to a fifth embodiment.

### DESCRIPTION OF THE EMBODIMENTS

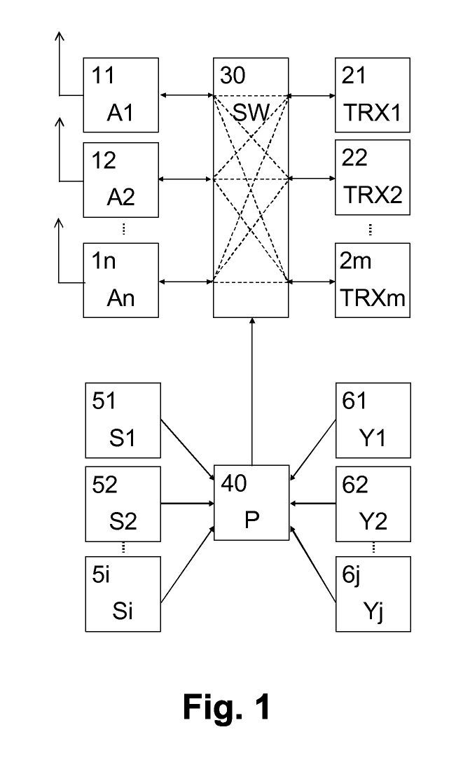

A first example embodiment will now be described based on a wireless multi-antenna device as shown in FIG. 1. The multi-antenna device may be provided in a transceiver system, in which at least one mobile station (or user equipment (UE) in 3G terminology) or other portable device is radio-connected to at least one base station device (or Node B in 3G terminology) or other access device.

However, it will be apparent from the following description and is therefore explicitly stressed that the present invention may be applied to any other network architecture with different radio access technologies involving an apparatus which may be portable or fixed (for example base station devices, access points or other access devices) capable of being operated in different operating modes and/or using different protocols.

FIG. 1 shows a schematic block diagram of a transmit and receive unit according to the first example embodiment, such as a mobile station, which is configured to support or implement the suggested advanced multi-mode antenna switching. Access to a wireless or radio network is provided by a first number m of transceiver/transmitter/receiver circuits or units 21 to 2m capable of receiving and/or transmitting radio frequency (RF) signals via a second number n of antennas (A1 to An) 11 to 1n. As an alternative the transceiver/transmitter/receiver units (TRX1 to TRXm) 21 to 2m may comprise or may be replaced by separate transmitter and/or receiver units with separate transmission and receiving paths. A switching matrix 30 selectively connects all of the transceiver units 21 to 2m to all or at least some of the antennas 11 to 1n responsive to or based on a control input of a processor (for example central processing unit or other processor circuit) 40 which may be controlled by a corresponding software routine. The switching matrix 30 may be implemented based on an analog or digital semiconductor circuit.

In various, but not necessarily all, embodiments, the number of radio protocols of the transmit and receive unit may be larger than the number of discrete antennas or antenna radiators. In a more specific example, the number of antennas per transmit and receive unit may be calculated based on the maximum number of concurrent protocols which are required or desired to be operated at any one time. The antennas 11 to 1n may be configured to be capable of being tuned to all or most protocols required. They may be assigned or switched dynamically by the switching matrix 30 under control of the processor 40 based on sensor signals received from a plurality of sensors (S1 to Si) 51 to 5i. The sensors 51 to 5i are configured to detect a mode of use which means how the device is used (for example, slide open or closed, fold open or closed, etc) or held (for example, in hand or next to head, or talking, browsing, gaming, viewing, listening, typing, etc). Additionally, inputs (Y1 to Yj) 61 to 6j may be provided for inputting information on which protocols are operative or active, what programs or applications are running, which antennas are connected to which transceivers/transmitters/receivers, how strong the signal being received from each receiver is, and feedback from base stations on how strong the signal is that they are receiving from the device (at least for those base stations supporting protocols that have this feature). The number of use and application based combinations could easily amount to hundreds.

Furthermore, the switching matrix 30 may be replaceable or exchangeable to allow future adoption of additional transceiver/transmitter/receiver units, and possibly change or add extra antennas as needed. The software which controls the processor 40 or the whole transmit and receive device may also be reconfigurable, for example by storing it on a replaceable storage medium or in a re-writable memory (as shown for example in FIG. 5).

Thus, in the first example embodiment, the n reconfigurable antennas 11 to 1n may be provided, which may be switched by the processor-controlled switching matrix 30 to connect them to any of the m transceiver units 21 to 2m, where m may be larger than n. The antenna switching, selection or assigning by the processor 40 is based on inputs 61 to 6j, which provide information on which protocols are operative or active, what programs or applications are running, which antennas are connected to which transceivers/transmitters/receivers, how strong the signal being received from each receiver is, and feedback from base stations on how strong the signal is that they are receiving from the device (at least for those base stations supporting protocols that have this feature), and outputs of the sensors 51 to 5i, which determine how the device is being used (how a person or user is holding the device, which orientation the device is in, or which features of the device are open or closed (mechanical mode), etc.). The antenna switching, selection or assigning by the processor 40 thus depends on the inputs 61 to 6j and outputs from the sensors 51 to 5i.

Addition of new transceiver/transmitter/receiver units may be allowed without addition of any new antennas and without any changes to the antennas 11 to 1n, as long as they can be tuned to the required frequencies. However, then, a new switching matrix 30 would be needed to support the additional transceiver/transmitter/receiver units. Furthermore, at least one of the antennas 11 to 1n should be able to be tuned to all or most of the frequencies supported by all the transceiver/transmitter/receiver units 21 to 2m in the transmit and receive unit.

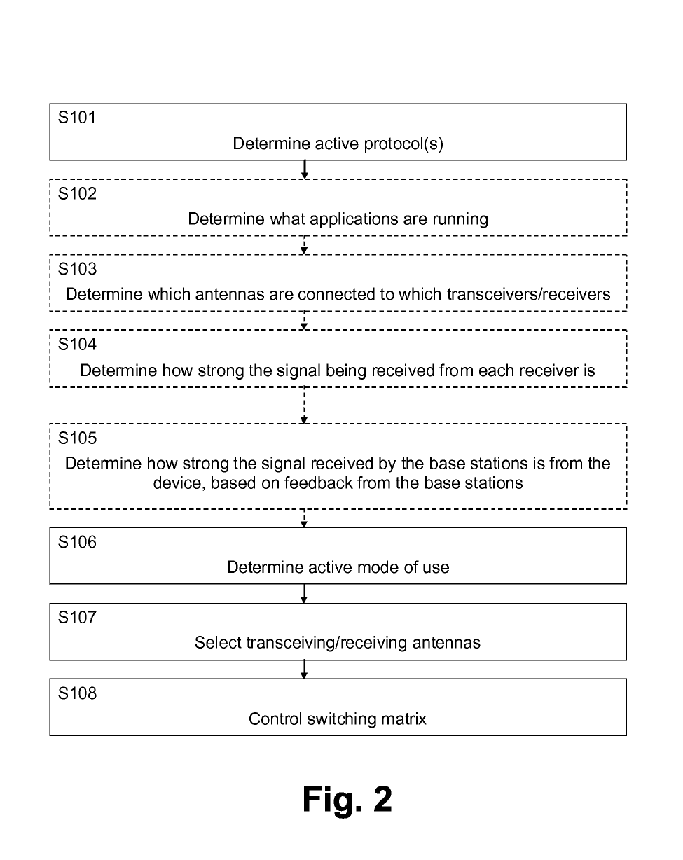

FIG. 2 illustrates a flow diagram of a method for antenna assignment or selection according to a second example embodiment, which may be performed in the processor 40 of FIG. 1.

At step S101, active protocols of the transceiver units 21 to 2m are determined, for example, based on corresponding sensor outputs or other signalling provided by the transceiver units 21 to 2m. Additionally, at least one of optional steps S102 to S105 may be provided. At step S102, the applications running on the corresponding apparatus are determined. In step S103, the current configuration of the antennas and switch matrix is determined and this information will be used in conjunction with the information collected in step S104 and step S105. In step S104, the strength of the signal that is being received by each receiver is determined. In step S105, the strength of the signal received by the base stations from the device, based on feedback from the base stations, is determined. Step S104 will not be used if no receivers were active before this step. Step S105 will not be used if there is no feedback from any base stations on the signal received from the device. Step S103 will not be used if steps S104 and S105 are not used. For example, if no transceivers or receivers were active long enough to collect any information in steps S104 or S105, then steps S103, S104 and S105 would not influence the configuration of the antennas nor switch matrix. In Step S106, a currently active mode of use is determined, for example, based on other sensor outputs or other signalling. It is noted that the steps S101 through S106 could be rearranged in any order.

At step S107, at least one transceiving/receiving antenna is selected and assigned to the transceiver/receiver unit(s) with the determined active protocol(s). Based on the result of step S107, the switching matrix 30 is controlled in step S108 to provide the selected connection(s).

The optional steps S104 and S105 provide a process where the signal strength of each active protocol is determined (if possible) for each available antenna. In many cases, the protocols being used may support switched diversity, which can be used to provide a sampling method for determining how well each antenna is picking up signals for each active protocol. This information could then be used in the selection process of matching transceivers with antennas. Since this type of search could take a long time, the initial selection of antennas could be done based on other input, and then be adjusted based on signal strength data collected.

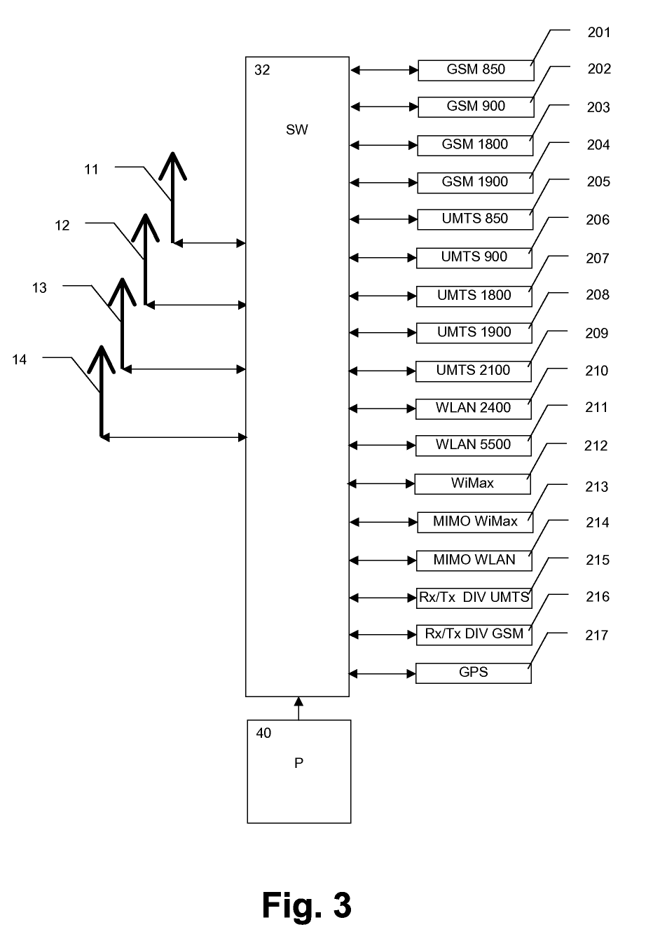

FIG. 3 shows a schematic block diagram of a transmit and receive device according to a third example embodiment. It is assumed here, that the transmit and receive device comprises four antennas 11 to 14, each tunable to all frequencies of all transceivers or receivers, and that the transmit and receive device supports the following radio protocols: GSM 850/900/1800/1900, UMTS 850/900/1800/1900/2100, WLAN 2400/5500, WiMax, GPS, RX/TX diversity for GSM, Rx/TX diversity for UMTS, MIMO for WLAN, MIMO for WiMax. In FIG. 3, individual radio protocols are depicted as individual processing blocks 201 to 217, of which individual ones thereof may be implemented or provided in a joint processing block or circuit. Here, a switching matrix 32 is controlled by a processor 40 based on sensor inputs or other inputs (not shown) connected to at least one of the processing blocks 201 to 217 and to at least one of the antennas 11 to 14.

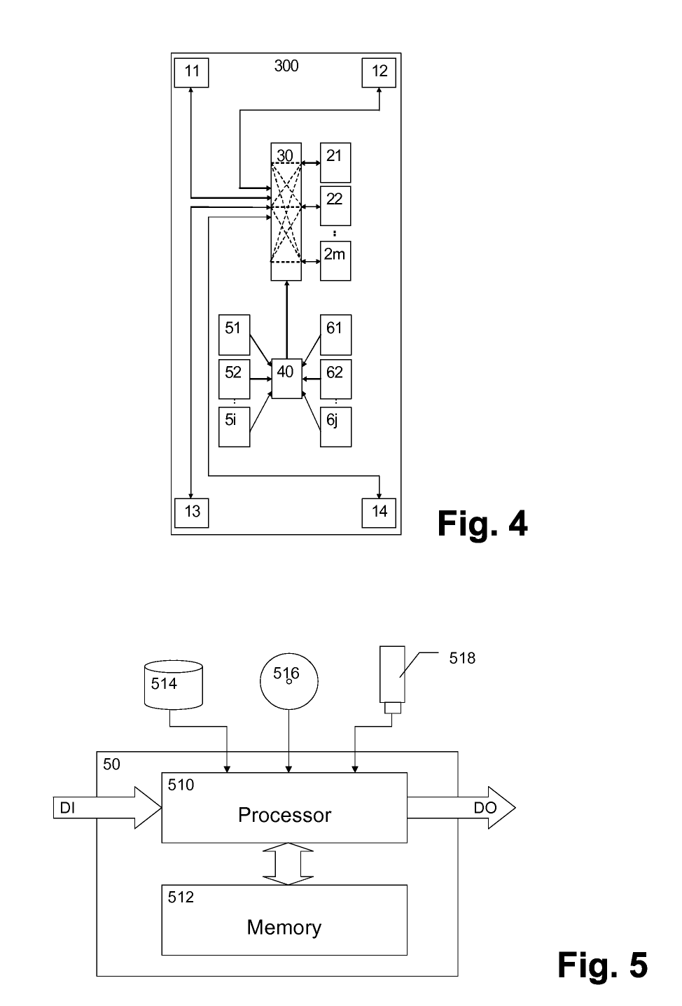

FIG. 4 shows a schematic top view of a transmit and receive device (for example a mobile phone or PDA or the like) according to a fourth example embodiment as a monoblock 300 having four antennas 11 to 14 located at or near its four corners. It is noted that the antennas 11 to 14 may be of any shape and are depicted as square shaped patterns for reasons of simplicity only. It is pointed out that other numbers or other locations of the antennas could be selected as well. Additionally, the transceiver/transmitter/receiver circuits or units 21 to 2m, the switching matrix 30, the processor 40, the inputs 61 to 6j, and the sensors 51 to 5i of FIG. 1 are shown without any specific reference to their actual location within or on the monoblock 300. These components can be located at any suitable position of the transmit and receive device. As to their operation and interaction, it is referred to the above parts of the description which relate to these components.

FIG. 5 shows a schematic block diagram of a software-based implementation of the proposed multi-mode antenna switching scheme according to a fifth example embodiment. Here, the transmit and receive device comprises a processing unit 510, which may be any processor or computer device with a control unit which performs control based on software routines of a control program stored in an internal memory 512 and/or external memory or storage devices, such as a hard disc drive 514, a disc-based medium 516 (such as fir example a floppy disc or CD-ROM (Compact Disc Read Only Memory) or DVD-ROM (Digital Versatile Disc ROM), or a memory stick 518. Program code instructions are fetched from at least one of the internal or external memories 512, 514, 516, 518 and are loaded to the control unit of the processing unit 510 in order to perform the processing steps of the above functionalities described in connection with FIG. 2 or with the respective blocks of FIGS. 1 and 3. These processing steps may be performed on the basis of input data Di and may generate output data DO, wherein the input data Di may correspond to the sensor outputs and the output data DO may correspond to control information used for selecting or assigning the antennas.

In the above first to fifth embodiments, the modes of use may be determined by the mechanical mode or configuration of the device, and input from any sensors (for example, accelerometer, proximity sensor, touch sensor, voice sensor etc.), and what software is running. The selection of antennas may for example be based on a user effect (e.g. head and hand loading) of the mode of use, and a least one of hearing aid compliance (HAC) of RF emissions, specific absorption rate (SAR) compliance, mechanical mode of the device, battery conservation, signal strength (received by the device or base station) of the active protocols, for example RSSI (Received Signal Strength Indicator), etc.

In the following, some examples for use cases are described.

A single antenna at the bottom of the transmit and receive device is assigned to a GSM voice call in use against the head of the user in a strong signal environment.

A first antenna at the bottom of the device may be assigned for a main GSM application (typically because the first antenna may provide the least head and hand effect), and a second antenna at the top of the device may be assigned for an Rx/Tx diversity GSM antenna to achieve best spatial diversity for a GSM voice call in use against the head in a weak signal environment.

A UMTS application may be assigned to an antenna at the top (least hand loss), a WiMax application may be assigned to an antenna at the top (least current consumption with best link due to least hand loss), a GPS application may be assigned to an antenna at the bottom (can tolerate the hand loss because of the strong signal), and a BT application may be assigned to an antenna at the bottom (can also tolerate the higher hand loss), in case of content rich location based services using GPS and WiMax, while talking via UMTS and using a BT headset, while being held in the hand in portrait mode (weak UMTS link, strong GPS link and strong WiMax link).

A GPS application may be assigned to an antenna at the top of the device (low hand loss, and if the two top antennas had different patterns, then the one with the best sky coverage with the display at 70 degrees from vertical would be selected), a UMTS application may be assigned to an antenna at the top of the device (least hand loss), in case of location based services using GPS and UMTS while being held in the hand with the display 70 degrees from vertical.

To summarize, a method, an apparatus, and a computer program for providing multi-mode antenna switching have been described, wherein a processor is configured to determine active radio protocols of a radio communication and a mode of use the apparatus, and to control selection of at least one antenna for the radio communication in response to which radio protocols are active and how the apparatus is used or held.

The blocks illustrated in FIG. 2 may represent steps in a method and/or sections of code in the computer program. The illustration of a particular order to the blocks does not necessarily imply that there is a required or preferred order for the blocks and the order and arrangement of the blocks may be varied. Furthermore, it may be possible for some steps to be omitted.

It is to be noted that the present invention is not restricted to the embodiment described above, but may be implemented in any network environment involving multi-antenna transmission and/or reception with various radio protocols. The above embodiments may be combined in any way. Any antenna arrangement and number of antennas as well as any type of sensors for determining which radio protocols are active and how the device is used or held may be used. The embodiment may thus vary within the scope of the attached claims.

1. An apparatus comprising:
a processor configured to determine at least one active radio protocol of radio communication and a mode of use of the apparatus, and to control selection of at least one of a plurality of antennas to be used for the radio communication in response to the at least one determined active radio protocol and the determined mode of use of the apparatus.

2. The apparatus according to claim 1, wherein the processor is configured to determine the mode of use based on at least one of a sensor input, a mechanical mode of the apparatus, and an active software program.

3. The apparatus according to claim 1, wherein the processor is configured to control selection of at least one antenna based on a user effect of the mode of use, and at least one of an emissions compliance of a hearing aid, a specific absorption rate compliance, a mechanical mode of the apparatus, a battery conservation status, and a signal strength received by the apparatus or an access device of at least one active protocol.

4. The apparatus according to claim 1, wherein the processor is configured to be controlled by a reconfigurable software.

5. The apparatus according to claim 1, wherein at least one active radio protocol comprise at least one of a cellular protocol, a wireless local area network protocol, a global positioning system protocol, a digital video broadcasting protocol, a Bluetooth protocol, a reception/transmission diversity protocol and a MIMO protocol.

6. The apparatus according to claim 1, further comprising:
a plurality of antennas; and
a switching matrix configured to select at least one of the plurality of antennas, and to couple at least one selected antenna to at least one of a plurality of transmitters and receivers;
wherein the processor is configured to control the switching matrix.

7. The apparatus according to claim 6, wherein the number of radio protocols used by the radio transmitters or receivers is larger than the number of the plurality of antennas.

8. The apparatus according to claim 6 or 7, wherein the number of the plurality of antennas corresponds to the maximum number of concurrent radio protocols which can be operated at any one time.

9. The apparatus according to claim 7, wherein at least one of the plurality of antennas can be tuned to frequency ranges of a plurality of the radio protocols.

10. The apparatus according to claim 6, wherein the switching matrix is configured to couple each of the plurality of antennas to at least some of the plurality of radio transmitters or receivers.

11. The apparatus according to claim 6, wherein the switching matrix is configured as a replaceable unit.

12. The apparatus according to claim 6, further comprising a plurality of sensors for determining at least one of the mode of use and the active radio protocols.

13. The apparatus according to claim 12, wherein the sensors are configured to detect at least one of an orientation, an open feature, and a way a user is holding the apparatus.

14. An apparatus comprising a processor and a memory storing executable instructions that control the processor configured to determine at least one active radio protocol of a radio communication and a mode of use of the apparatus, and to control selection of at least one of a plurality of antennas to be used for the radio communication in response to the determined at least one active radio protocol and the determined mode of use of the apparatus.

15. A portable electronic device comprising an apparatus as claimed in any of the preceding claims.

16. A method comprising:
determining at least one active radio protocol of a radio communication and a mode of use of a communication apparatus; and
selecting at least one of a plurality of antennas in response to the at least one determined active radio protocol and the determined mode of use of the apparatus.

17. The method according to claim 16, further comprising determining the mode of use based on at least one of a sensor input, a mechanical mode of the communication apparatus, and an active software program.

18. The method according to claim 16, further comprising selecting at least one antenna based on a user effect of the mode of use and at least one of an emissions compliance of a hearing aid, a specific absorption rate compliance, a mechanical mode of the apparatus, a battery conservation status, and a signal strength received by the apparatus or an access device of the at least one active protocol.

19. The method according to claim 16, further comprising tuning at least one of the plurality of antennas to frequency ranges of a plurality of the radio protocols.

20. A computer program embodied on a computer-readable storage medium, the computer program being configured to control a processor to perform a process comprising determining at least one active radio protocol of a radio communication and a mode of use of a communication apparatus; and controlling selection of at least one antenna for the apparatus in response to the at least one determined active radio protocol and the determined mode of use of the apparatus.

21. The computer program according to claim 20, further configured to control the processor to perform a process comprising determining the mode of use based on at least one of sensor inputs, a mechanical mode of the apparatus, the previous configuration of the antennas and switch matrix, the received signal strength of the previously active receivers, and the signal strength received by the base station for previously active transmitters, and a type of software running on the apparatus.

22. The computer program according to claim 20, further configured to control the processor to perform a process comprising selecting at least one antenna based on a user effect of the mode of use, and at least one of an emissions compliance of a hearing aid, a specific absorption rate compliance, a mechanical mode of the apparatus, a battery conservation status, and a signal strength received by the apparatus or an access device of determined active protocols.

23. The computer program according to claim 20, further configured to control the processor to perform a process comprising tuning at least one of the plurality of antennas to frequency ranges of a plurality of the radio protocols.
